(19) United States
(12) Patent Application Publication
(10) Pub. No.: US 2011/0032168 A1
(43) Pub. Date: Feb. 10, 2011

(54) ANTENNA USING COMPLEX STRUCTURE HAVING PERPENDICULAR PERIOD BETWEEN DIELECTRIC AND MAGNETIC SUBSTANCE

(76) Inventors: Byung Hoon Ryou, Seoul (KR); Won Mo Sung, Siheung-si (KR); Jeong Keun Ji, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/936,903

(22) PCT Filed: Apr. 8, 2009
(86) PCT No.: PCT/KR09/01805

§ 371 Date: Oct. 7, 2010

(30) Foreign Application Priority Data
Apr. 8, 2008 (KR) 10-2008-0032421

(51) Int. Cl. H01Q 1/38; H01Q 5/01

(52) U.S. Cl. 343/787

(57) ABSTRACT

The invention provides an antenna that uses a complex structure in which a dielectric having a low dielectric constant and a magnetic substance having high magnetic permeability are arranged perpendicularly and periodically to improve the gain, efficiency, and bandwidth of the antenna while maintaining the miniaturization of the antenna which is an advantage of known antennas using a dielectric having a high dielectric constant. For this purpose, the provided antenna is characterized by including a substrate and a radiation patch formed on the substrate. The substrate is formed with a complex structure having a perpendicular period between the dielectric and the magnetic substance.

Antenna using complex structure having perpendicular period between dielectric and magnetic substance

### TECHNICAL FIELD

The present invention relates to an antenna using a complex structure in which a dielectric having a low dielectric constant and a magnetic substance having high magnetic permeability are arranged perpendicularly and periodically to improve the gain, efficiency, and bandwidth of the antenna while maintaining the miniaturization of the antenna which is an advantage of known antennas using a dielectric having a high dielectric constant.

### BACKGROUND ART

Recently, a variety of digital multimedia broadcasting systems including a terrestrial digital multimedia broadcasting (DMB) system started to provide services. Accordingly, mobile terminals capable of receiving DMB as well as broadcasting systems have been being actively developed.

Furthermore, the development of a complex terminal, which is grafted onto widely commercially used current mobile cellular phone systems to be provided with two services through a single mobile terminal, is being actively made.

However, there are restrictions on the development of mobile terminals because frequency bands adopted for DMB are in the range of 174 to 216 MHz corresponding to low frequency bands such as UHF or VHF. One of the restrictions relates to the size of an antenna used for a mobile terminal.

In general, the size of an antenna increases as the frequency used by the antenna decreases. To manufacture an antenna for UHF or VHF, the antenna requires a length of several tens centimeters. However, this long antenna is not suitable for mobile terminals. Accordingly, researches and developments for reducing the sizes of antennas for mobile terminals have been being carried out.

A conventional monopole type whip antenna or helical antenna, which has been widely used, has a structure projected to the outside of a mobile terminal when mounted in the mobile terminal, and thus this antenna is not used for current mobile terminals. Accordingly, internal antennas that can be built in a mobile terminal so as not to be projected to the outside of the mobile terminal attract intentions and various mobile terminals using these internal antennas are introduced.

One of the internal antennas is a printed circuit board (PCB) antenna. The PCB antenna is in a flat shape, has a simple circuit configuration and low manufacturing cost compared to coil type antennas, and can solve problems in manufacturing processes.

FIG. 1(a) is a plan view of a conventional PCB antenna and FIG. 1 (b) is a cross-sectional view taken along line I-I′ of FIG. 1(a).

Referring to FIG. 1, the conventional PCB antenna includes a PCB 10 on which components of a mobile terminal are mounted and an antenna pattern 20 which is formed on the PCB 10 and functions as a radiator. In general, FR4 is widely used as a material of a PCB and the antenna pattern is printed with Cu.

However, even in the PCB antenna shown in FIG. 1, the size of the antenna is associated with the frequency used by the antenna, and thus the PCB antenna is very long. Since the sizes of current mobile terminals become small while the number of functions thereof increases, the internal antennas also restrict miniaturization of the mobile terminals.

Particularly, mobile terminals for DMB operate in UHF or VHF in the range of 174 to 216 MHz, and thus the DMB mobile terminals are difficult to use the conventional PCB antenna as shown in FIG. 1 and require a small-size antenna.

To solve this problem, a technique of manufacturing a substrate using a dielectric with a high dielectric constant and forming a radiating pattern on the substrate has been developed and used. However, this technique inevitably reduces the gain and bandwidth of an antenna although it can accomplish a small-size antenna.

That is, an antenna using a dielectric with a high dielectric constant is not suitable for digital multimedia broadcasting systems including terrestrial DMB systems which require an antenna with a wide bandwidth and a high gain. Accordingly, the development of a technique capable of reducing the size of an antenna while increasing the bandwidth and gain of the antenna is required.

### DISCLOSURE

### Technical Problem

Accordingly, the present invention has been made to solve the above-mentioned problems occurring in the conventional art, and a primary object of the present invention is to provide an antenna using a complex structure in which a dielectric having a low dielectric constant and a magnetic substance having high magnetic permeability are arranged perpendicularly and periodically to improve the gain, efficiency, and bandwidth of the antenna while maintaining the miniaturization of the antenna which is an advantage of known antennas using a dielectric having a high dielectric constant.

### Technical Solution

To accomplish the object of the present invention, there is provided an antenna using a complex structure having a perpendicular period between a dielectric and a magnetic substance, which comprises a substrate and a radiation patch formed on the substrate, wherein the substrate is formed with a complex structure in which a dielectric and a magnetic substance are arranged perpendicularly and periodically.

The antenna may resonate in multiple bands.

The radiation patch may have a size of 170 mm×170 mm and the substrate may have a size of 300 mm×300 mm×20 mm.

The substrate may be formed in such a manner that a dielectric and a magnetic substance are perpendicularly arranged at a period of 10 mm, 20 mm, 30 mm, 40 mm, 60 mm or 100 mm.

The dielectric may have a dielectric constant of 2.2 and a permeability of 1.0 and the magnetic substance may have a dielectric constant of 16 and a permeability of 16.

To accomplish the object of the present invention, there is also provided a wireless terminal device comprising the antenna.

### Advantageous Effects

As described above, the present invention provides an antenna using a complex structure in which a dielectric having a low dielectric constant and a magnetic substance having high magnetic permeability are arranged perpendicularly and periodically to improve the gain, efficiency, and bandwidth of the antenna while maintaining the miniaturization of the antenna which is an advantage of known antennas using a dielectric having a high dielectric constant.

### DESCRIPTION OF DRAWINGS

Further objects and advantages of the invention can be more fully understood from the following detailed description taken in conjunction with the accompanying drawings, in which:

FIG. 1(a) is a plan view of a conventional PCB antenna that is an internal antenna;

FIG. 1(b) is a cross-sectional view taken along line I-I′ of FIG. 1 (a);

FIG. 2 illustrates an antenna using a complex structure in which a dielectric and a magnetic substance are arranged perpendicularly and periodically according to an embodiment of the present invention;

FIGS. 3 through 8 show return losses of patch antennas formed on complex structures having various perpendicular period structures; and

FIG. 9 shows a return loss of a patch antenna using a dielectric with a dielectric constant of about 35, which has the same size as the antenna according to an embodiment of the present invention.

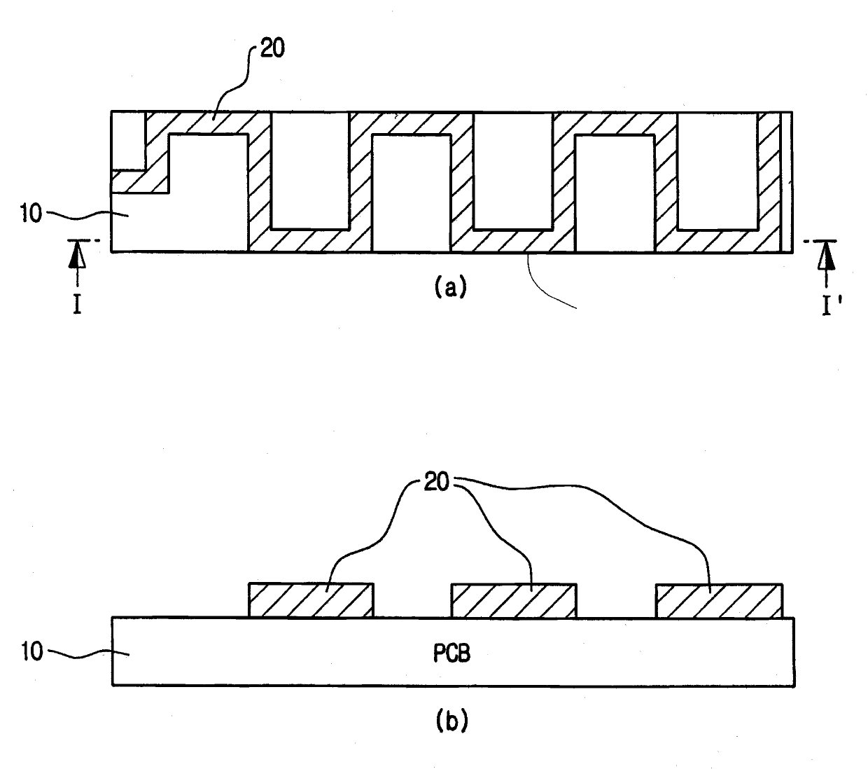

### BEST MODE

The attached drawings for illustrating preferred embodiments of the present invention are referred to in order to gain a sufficient understanding of the present invention, the merits thereof, and the objective accomplished by the implementation of the present invention.

Hereinafter, the present invention will be described in detail by explaining preferred embodiments of the invention with reference to the attached drawings.

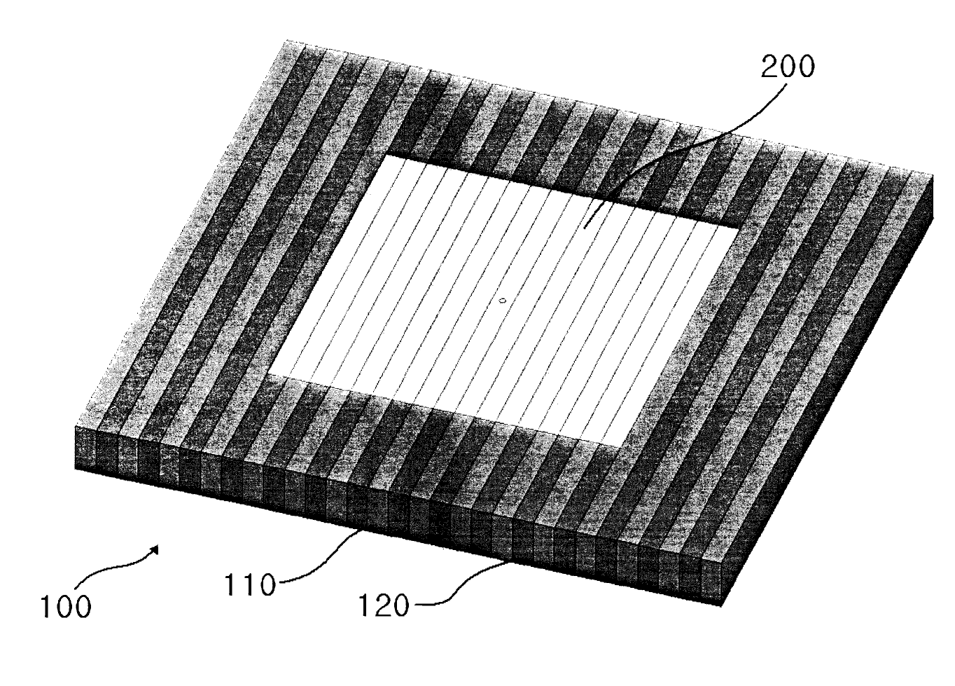

FIG. 2 illustrates an antenna using a complex structure having a perpendicular period of a dielectric and a magnetic substance according to an embodiment of the present invention.

Referring to FIG. 2, the antenna includes a substrate 100 and a radiation patch 200 formed on the substrate 100. The substrate 100 is formed in a complex structure having a perpendicular period of a dielectric 110 and a magnetic substance 120.

More specifically, the dielectric 110 may have a low dielectric constant and the magnetic substance 120 may have high magnetic permeability. For example, the dielectric 110 has a dielectric constant of 2.2 and magnetic permeability of 1.0 and the magnetic substance has a dielectric constant of 16 and magnetic permeability of 16.

The radiation patch 200 may have a size of 170 mm×170 mm and the substrate 100 may have a size of 300 mm×300 mm×20 mm.

The operation property of the antenna according to the present invention, which has the above-described configuration, will now be explained with reference to the attached drawings and table.

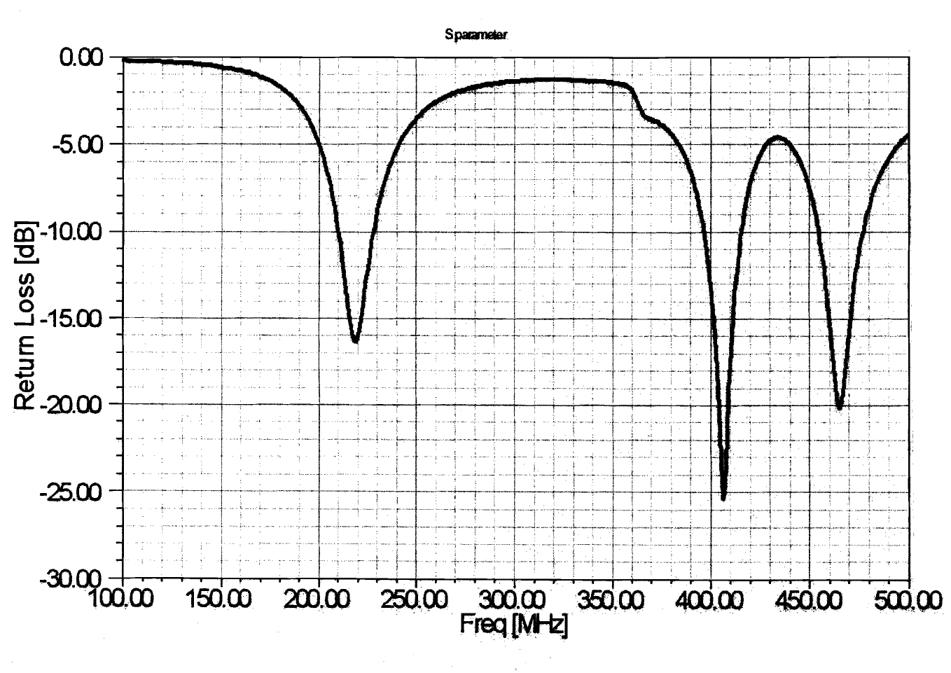

FIGS. 3 through 8 show return losses of patch antennas formed in complex structures having various perpendicular periods.

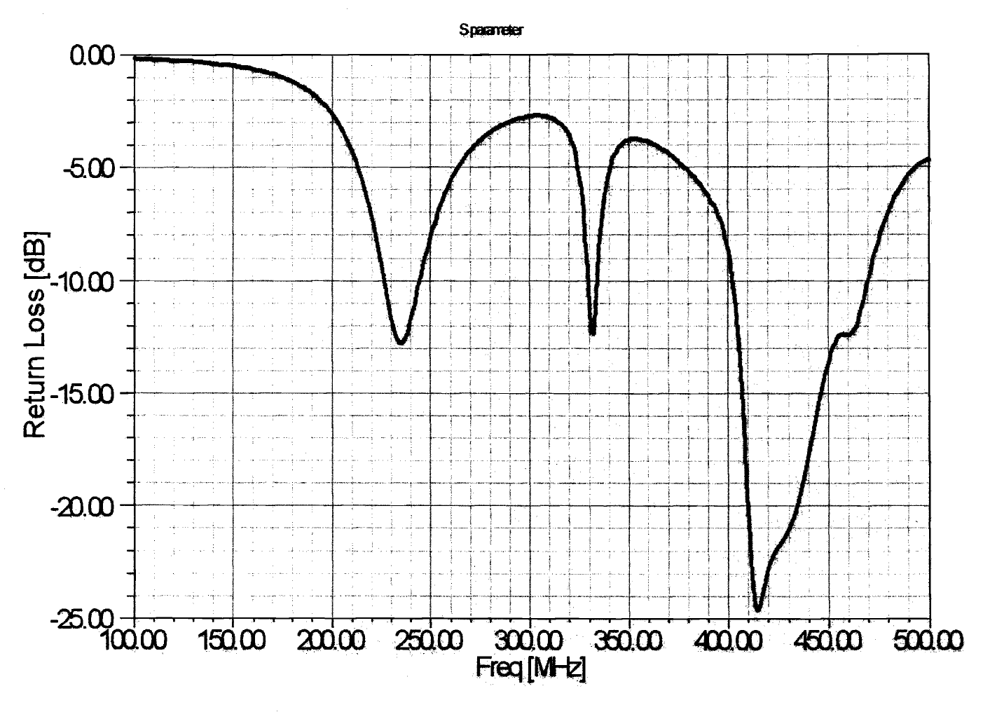

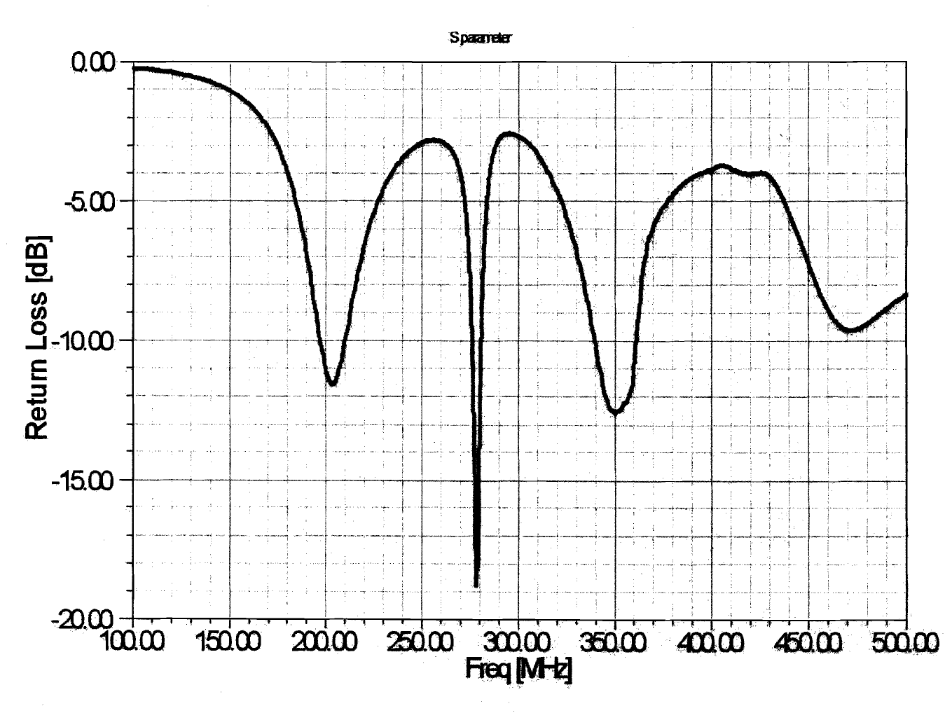

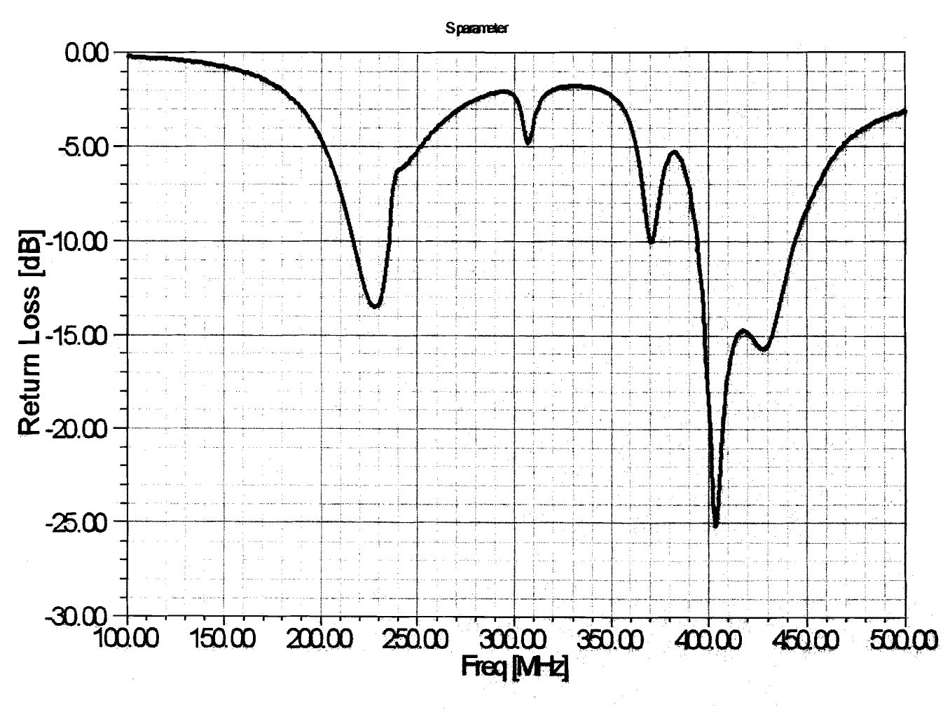

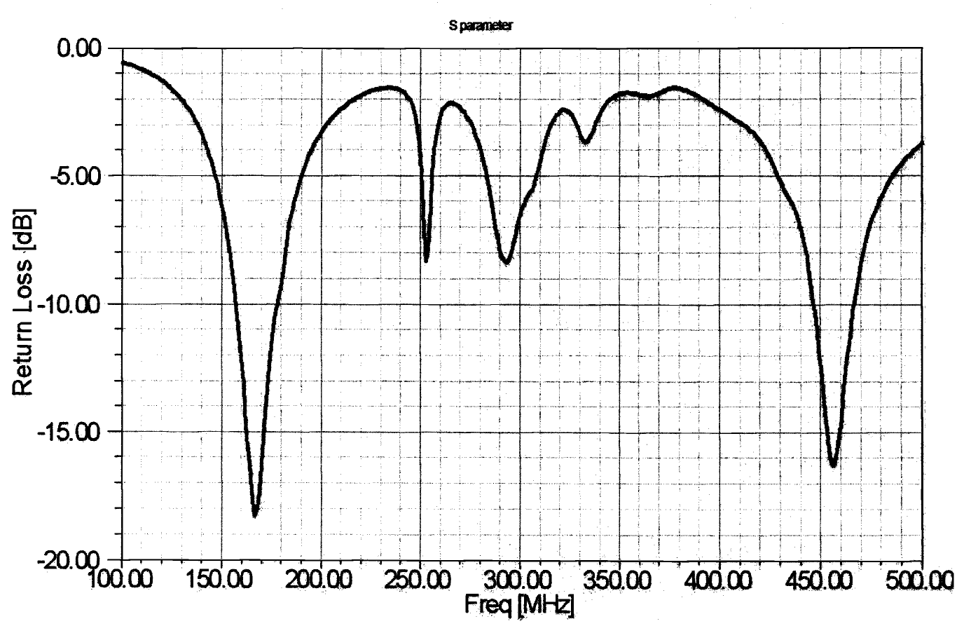

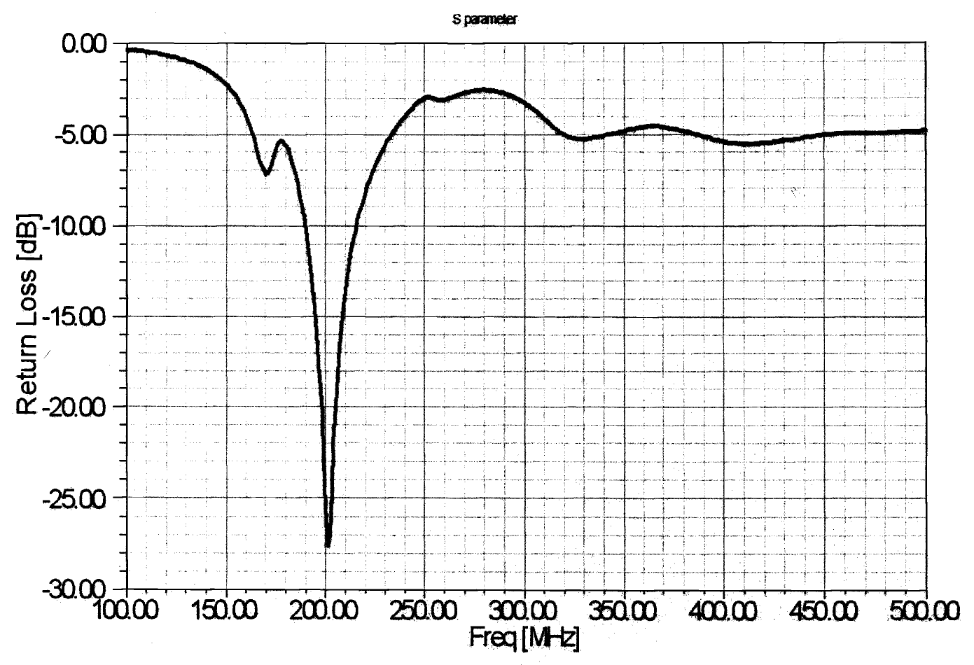

Specifically, FIG. 3 shows a return loss of a patch antenna having a dielectric and a magnetic substance perpendicularly arranged at a period of 10 mm, FIG. 4 shows a return loss of a patch antenna having a dielectric and a magnetic substance perpendicularly arranged at a period of 20 mm, FIG. 5 shows a return loss of a patch antenna having a dielectric and a magnetic substance perpendicularly arranged at a period of 30 mm, FIG. 6 shows a return loss of a patch antenna having a dielectric and a magnetic substance perpendicularly arranged at a period of 40 mm, FIG. 7 shows a return loss of a patch antenna having a dielectric and a magnetic substance perpendicularly arranged at a period of 60 mm, and FIG. 8 shows a return loss of a patch antenna having a dielectric and a magnetic substance perpendicularly arranged at a period of 100 mm.

As described above, the entire length of the complex structure of each antenna is 300 mm and the dielectric and the magnetic substance in each antenna are arranged at the same period.

Multiband antennas are obtained from the aforementioned structures. It can be confirmed from FIGS. 3 through 8 that high gains and efficiencies and wide bandwidths can be achieved.

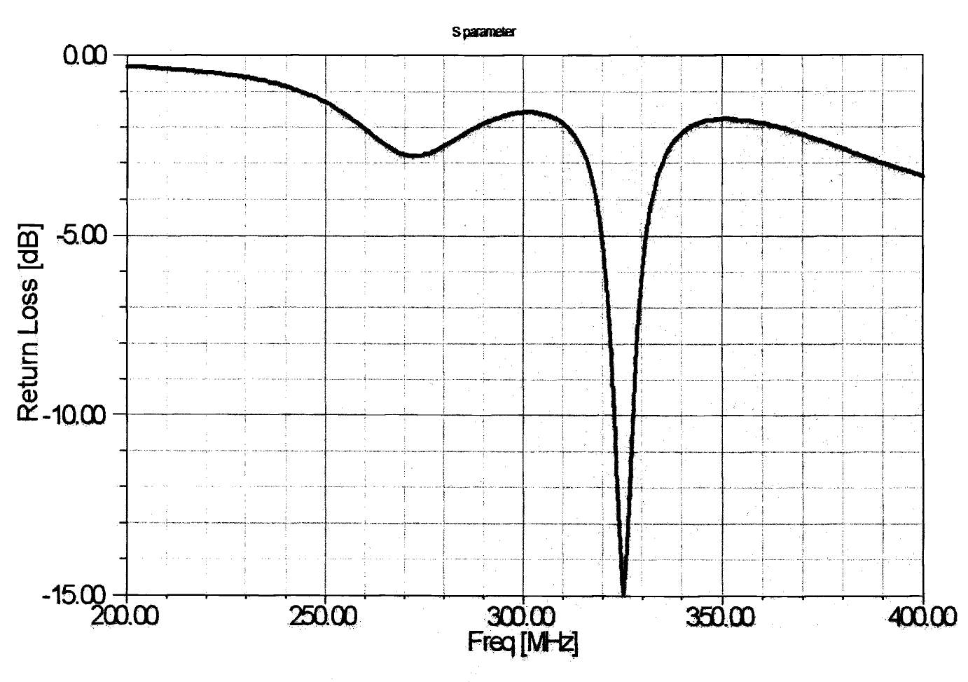

FIG. 9 shows a return loss of a patch antenna using a dielectric with a high dielectric constant of 35, which has the same size as the antenna according to the present invention.

Referring to FIG. 9, the antenna using the dielectric with a high dielectric constant has a narrow bandwidth and a low gain of about −15 dB as compared to the antenna using the complex structure in which the dielectric and the magnetic substance are arranged in the perpendicular period structure.

TABLE 1

| | Patch size | Bandwidth (%) | Peak Gain | Efficiency |
|---|---|---|---|---|
| | (lambda0) | (−10 dB) | (dBi) | (%) |
| Period 1 cm | 0.12 | 8.22 | −10.34 | 90.43 |
| Period 2 cm | 0.13 | 8.09 | −9.20 | 84.91 |
| Period 3 cm | 0.12 | 6.40 | −10.24 | 88.23 |
| Period 4 cm | 0.13 | 7.89 | −9.91 | 87.17 |
| Period 6 cm | 0.09 | 12.57 | −15.38 | 100.37 |
| Period 10 cm | 0.11 | 12.44 | −1.68 | 93.52 |
| Dielectric | 0.18 | 1.54 | −13.75 | 29.63 |
| layer (er = 35) | | | | |

Table 1 shows comparison of antenna properties of the six implementations of the present invention shown in FIGS. 3 through 8 to the properties of the antenna using the dielectric with a high dielectric constant.

Data shown in Table 1 are obtained by calculating the bandwidth, gain and efficiency of the first resonance frequency. It can be confirmed from Table 1 that the six implementations of the present invention have improved bandwidths, gains and efficiencies as compared to the antenna using the dielectric with a high dielectric constant when the six implementations of the present invention and the compared antenna using the dielectric with a high dielectric constant have the same size. Furthermore, various resonance frequencies can be obtained by changing a feeding point for each perpendicular period structure.

As described above, the present invention can design small-size antennas having improved antenna gains and bandwidths and various resonance frequencies by using a complex structure in which a dielectric having a low dielectric constant and a magnetic substance having a high permeability are arranged perpendicularly and periodically.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An antenna using a complex structure having a perpendicular period of a dielectric and a magnetic substance, comprising:
a substrate; and
a radiation patch formed on the substrate,
wherein the substrate is formed with a complex structure in which a dielectric and a magnetic substance are arranged perpendicularly and periodically.

2. The antenna according to claim 1, wherein the antenna resonates in multiple bands.

3. The antenna according to claim 1, wherein the radiation patch has a size of 170 mm×170 mm and the substrate has a size of 300 mm×300 mm×20 mm

4. The antenna according to claim 3, wherein the substrate is formed in such a manner that a dielectric and a magnetic substance are perpendicularly arranged at a period of 10 mm, 20 mm, 30 mm, 40 mm, 60 mm or 100 mm.

5. The antenna according to claim 4, wherein the dielectric has a dielectric constant of 2.2 and a permeability of 1.0 and the magnetic has a dielectric constant of 16 and a permeability of 16.

6. A wireless terminal device comprising an antenna using a complex structure having a perpendicular period of a dielectric and a magnetic substance, comprising:
a substrate; and
a radiation patch formed on the substrate,
wherein the substrate is formed with a complex structure in which a dielectric and a magnetic substance are arranged perpendicularly and periodically.
